(19) United States
(12) Patent Application Publication
(10) Pub. No.: US 2003/0137142 A1
(43) Pub. Date: Jul. 24, 2003

(54) Furniture slide

(76) Inventor: Donald V. Edwards, Irwin, PA (US)

Correspondence Address: CAROTHERS AND CAROTHERS, Suite 500, 445 Fort Pitt Blvd., Pittsburgh, PA, 15219, US

(21) Appl. No.: 10/055,643

(22) Filed: Jan. 22, 2002

(51) Int. Cl. A62B 9/04

(52) U.S. Cl. 280/845; 280/19

(57) ABSTRACT

A slide for placement between an object to be moved, such as furniture and flooring over which the object is to be moved. A sheet of substantially rigid material is provided and the bottom face of this sheet is for sliding on a floor surface and the top face is provided for support contact with the furniture or object to be moved. A cloth cover is also provided for fitting over the bottom face of the slide sheet and is provided with elastic securement to keep it attached to the slide sheet. This cloth cover further includes a non-slip elastomer interior backing surface which engages the bottom face of the furniture slide sheet to inhibit slippage therebetween so that the cloth cover does not become accidently dislodged from the slide sheet.

### BACKGROUND OF THE INVENTION

This invention pertains to a furniture slide for easily and efficiently moving heavy objects across building floors. This invention is especially concerned with multiple of such furniture slides that may be used in cooperation with one another for the movement of furniture across floor surfaces of varying texture.

In the moving industry and in the carpet cleaning industry, it is quite usual to face the situation of having to move large, heavy and sometimes awkwardly shaped furniture within the confines of buildings. The most common method used for moving heavy objects is for the movers or cleaners to pick the object up and carry it by hand, but this is not always a feasible or preferable arrangement. With the exception of moving furniture up and down stairways, or a special orientation of heavy or awkwardly shaped furniture which requires lifting, it has been found that placing a separate one piece slide under the object to be moved and over the surface to which it is being moved, is beneficial so that the article may be slid across the horizontal surfaces which it must traverse in order to be relocated or moved within the confines of the building.

Various other prior art devices have been suggested for placing under the legs of furniture or placing under a furniture base which does not include legs, in order that the furniture may be moved across the floor surfaces. Examples are disclosed in U.S. Pat. Nos. 5,984,360 and 6,206,424. One problem that exists with these devices is that adequate structure is not provided to maintain minimal friction between the sliding furniture slide and a hard floor surface. U.S. Pat. No. 5,984,360 discloses a cloth cover which fits over the furniture slide in order to provide minimal friction between the furniture slide and a hard floor surface.

This arrangement is a great improvement, but problems are still encountered in that the cloth cover tends to become dislodged from the furniture slide.

It is a principal object of the present invention to eliminate this problem.

### SUMMARY OF THE INVENTION

The furniture slide of the present invention is for placement between an object to be moved and flooring over which it is to be moved. The furniture slide of the present invention comprises a sheet of substantially rigid material having top and bottom faces wherein the bottom face is provided for sliding on a floor surface, and the top face is provided for support contact with an object to be moved. A cloth covering is provided for fitting over the bottom face of the furniture slide sheet and is further provided with means for attaching it to the sheet. The improvement resides in the cloth cover including a non-slip elastomer backing surface for engaging the bottom face of the furniture slide sheet to inhibit slippage therebetween. This prevents unintentional dislodgement or displacement of the cloth cover from the sheet making up the main body of the furniture slide.

This non-slip elastomer backing surface is adhered to the backing surface of the cloth cover and may be a sprayed-on or heat applied surface of a non-slip rubber or polymer.

### BRIEF DESCRIPTION OF THE DRAWINGS

Other objects and advantages appear hereinafter in the following description and claims. The accompanying drawings show, for the purpose of exemplification, without limiting the invention or appended claims, certain practical embodiments of the present invention wherein:

FIG. 1 is a perspective view of the substantially rigid sheet portion of the furniture slide according to the teachings of the present invention;

FIG. 2 is a left end view of the furniture slide shown in FIG. 1;

FIG. 3 is a top or plan view of the cloth cover for fitting over the bottom face of the furniture slide shown in FIGS. 1 and 2 in the combination of the present invention;

FIG. 4 is a perspective view illustrating the furniture slide structure of FIGS. 1 and 2 with the cloth cover of FIG. 3 partially applied;

FIG. 5 is a plan view of the combination shown in FIG. 4 with the cloth cover fully applied to the furniture slide of substantially rigid material; and

FIG. 6 is a bottom view of the structure illustrated in FIG. 5.

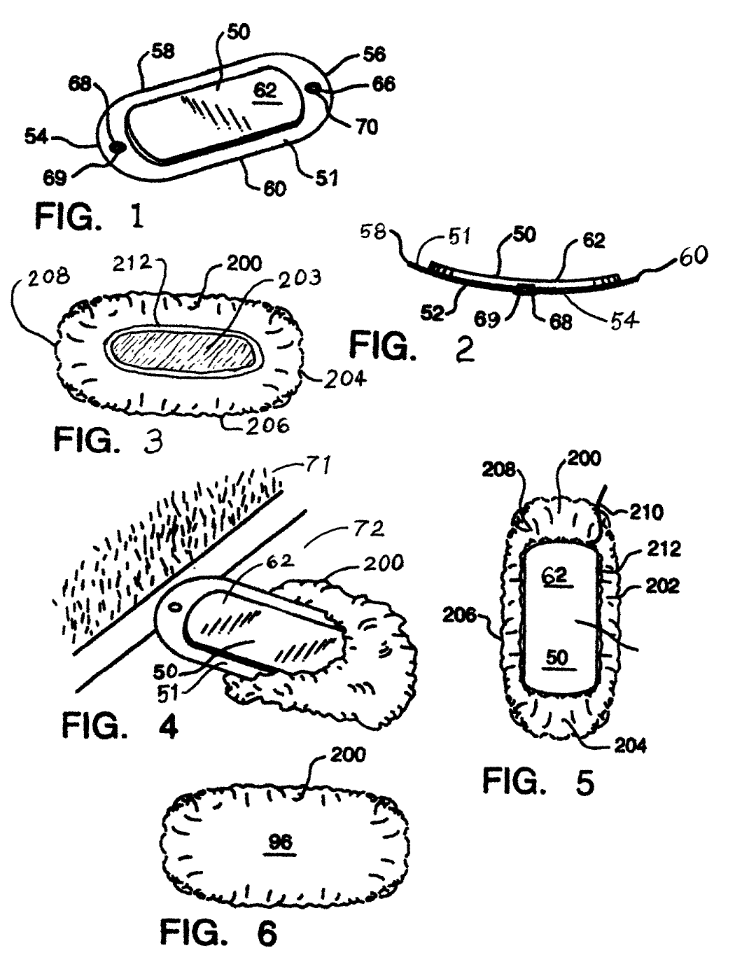

### DETAILED DESCRIPTION OF A PREFERRED EMBODIMENT

Referring to the drawings, the basic furniture slide 62 is comprised of a sheet 40 of substantially rigid material, such as a plastic sheet which is substantially rigid yet may be flexed. Sheet 40 has side edges 58 and 60 and curved end edges 54 and 56 and is provided further with grommets 68 and 66 at ends 54 and 56 respectively to provide grommet apertures 69 and 70 for the insertion of a rope or line.

Compressible material 50 is adhered to the top surface 51 of sheet 40 for non-slip engagement of its upper surface with a furniture leg or furniture base. The details of this structure are described in the two aforementioned U.S. patents and to this end the disclosures thereof are incorporated herein by reference.

Referring more particularly to FIGS. 3 through 6, a cloth cover 200 is provided for fitting over the bottom face 54 of sheet 40. Cloth cover 200 is provided with means for attachment to the sheet in the form of an elastic stretchable hem 212 which consists of a turned over hem of the material containing a stretchable or elastic ribbon. This arrangement permits the stretchable hem 212 to be expanded and slipped over the edges of sheet 40 as shown in FIGS. 4 and 5. In order to retain the cloth cover 200 in position, a pull string 210 (see FIG. 5) may also be provided which extends throughout the hem 212 and it is exposed as illustrated in order to close down the hem 212 and tie it in position.

When the cloth cover 200 is fully attached to the slide sheet 40 as illustrated in FIG. 5, the edges of sheet 40 and the top surface 51 and bottom surface 52 are fully covered as illustrated by side edges 202 and 206 of cloth cover 200 and end portions 200 and 204 of cloth cover 200. The bottom face 54 of the sheet member 40 is fully covered as illustrated by the bottom surface 96 of cover 200 as shown in FIG. 6. The only portion of furniture slide member 62 which is left exposed is the compressible material 50 as shown in FIG. 5.

With particular reference to FIG. 4, the slide unit 62 is used without cover 200 in order to slide over carpeted floor areas such as indicated at 71 and the cloth cover 200 is used in position over the furniture slide 62 when sliding the furniture over a hard smooth floor surface 72.

A principal feature of the present invention is illustrated in FIG. 3 wherein a non-slip elastomer backing surface 203 is provided for engaging the bottom face 54 of sheet 40 to inhibit slippage therebetween. This prevents the cloth cover 200 from becoming accidently dislodged when the combination of the cloth cover 200 and furniture slide 60 is utilized for sliding furniture over hard floor surfaces 72.

This non-slip elastomer backing surface 203 is provided in the form of an elastomer material which is adhered to the interior of cloth cover 200, such as by well known spraying techniques or heat application.

I claim:

1. A slide for placement between an object to be moved and flooring over which it is to be moved, which comprises:
a. a sheet of substantially rigid material having top and bottom faces, the bottom face for sliding on a floor surface and the top face for support contact with an object to be moved;
b. a cloth cover for fitting over said bottom face and having means for attachment to said sheet; and
c. said cloth cover including a non-slip elastomer backing surface for engaging said bottom face of said sheet to inhibit slippage therebetween.

2. The slide of claim 1, wherein said non-slip elastomer backing surface is adhered to said cloth cover.
